(19) United States
(12) Patent Application Publication
(10) Pub. No.: US 2011/0067202 A1
(43) Pub. Date: Mar. 24, 2011

(54) TRUCKLE

(76) Inventor: Chuan-Hai CHOU, Sanchong City (TW)

(21) Appl. No.: 12/564,549

(22) Filed: Sep. 22, 2009

(51) Int. Cl. B60B 33/00

(52) U.S. Cl. 16/45

(57) ABSTRACT

A truckle includes a swiveling shaft, a rack, a driving unit received in the swivel shaft, and an arresting unit assembled with the driving unit. The swiveling shaft defines a through hole near an end thereof, and has a bearing on another end thereof. The rack has an end connecting with the bearing. The driving unit includes a rotating member corresponding to the through hole, a push member corresponding to a peripheral of the rotating member. The arresting unit includes an axis pole extending into the sleeve for assembling with the push member, a gear disc mounted on the axis pole for corresponding to the latch portion, and an arresting block mounted below the gear disc and corresponding to the wheel. The truckle either limits direction solely or limits direction and rotation simultaneously. The truckle has firm structure and can be arrested reliably.

### BACKGROUND OF THE INVENTION

(a) Field of the Invention

The present invention relates to a truckle, and particularly to a truckle which either limits direction solely or limits direction and rotation simultaneously.

(b) Description of the Prior Art

A conventional truckle substantially comprises a base and a wheel pivoting to the base. An arresting unit is disposed between the base and the wheel. The arresting unit is a metal plate attached to the wheel. A shaft is provided on an end of the base for assembling the truckle to a bottom of a carried object. The wheel rotates to move the object, and at the same time, the shaft brings the base to rotate the wheel in multi-directions. As the object arrives at a target position, the arresting unit presses the wheel to stop.

The wheel of the conventional truckle can be pressed to limit its rotation. However, the truckle only limits rotation of the wheel but fails to determine direction of the wheel while arresting. Once the wheel is arrested, the truckle may change direction by the shaft. The truckle cannot limit rotation and direction effectively, thus can not meet practical requirement.

### SUMMARY OF THE INVENTION

To obviate the above drawback, accordingly, an object of the present invention is to provide a truckle which either limits direction solely or limits direction and rotation simultaneously and which has a firm structure and can be reliably arrested.

To achieve the above object, the truckle of the present invention comprises a swiveling shaft, a rack, a driving unit received in the swivel shaft, and an arresting unit assembled with the driving unit. The swiveling shaft defines a through hole near an end thereof, and has a bearing on another end thereof. The rack has an end connecting with the bearing, and a wheel is movably assembled on another end of the rack. A plastic shell envelops the rack. A projection extends from an inward surface of the rack. A latch portion is formed on an inward surface of the plastic shell. The driving unit includes a rotating member corresponding to the through hole, a push member corresponding to a peripheral of the rotating member, a sleeve telescopically mounted on the push member, and a resilient member on the sleeve and abutting the push member. The arresting unit includes an axis pole, a gear disc mounted on the axis pole for corresponding to the latch portion, and an arresting block mounted below the gear disc and corresponding to the wheel. The axis pole extends into the sleeve for assembling with the push member. A slot is defined in the gear disc for corresponding to the projection.

### BRIEF DESCRIPTION OF THE DRAWINGS

FIG. 1 is a perspective view of a truckle according to the present invention.

FIG. 2 is an exploded view of the truckle of FIG. 1.

FIG. 3 is a cross-sectional view of the truckle while rotating.

FIG. 4 is a cross-sectional view of the truckle while limiting direction.

FIG. 5 is a cross-sectional view of the truckle while limiting direction and rotation.

### DESCRIPTION OF THE PREFERRED EMBODIMENTS

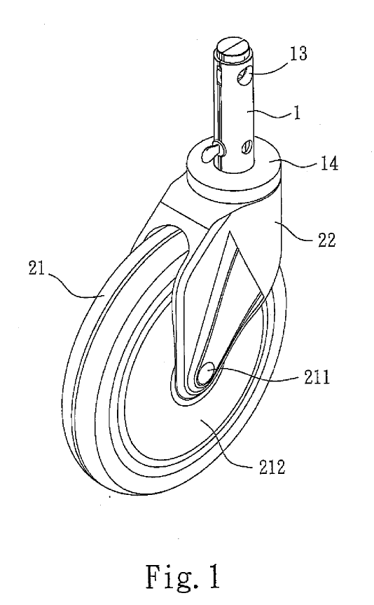

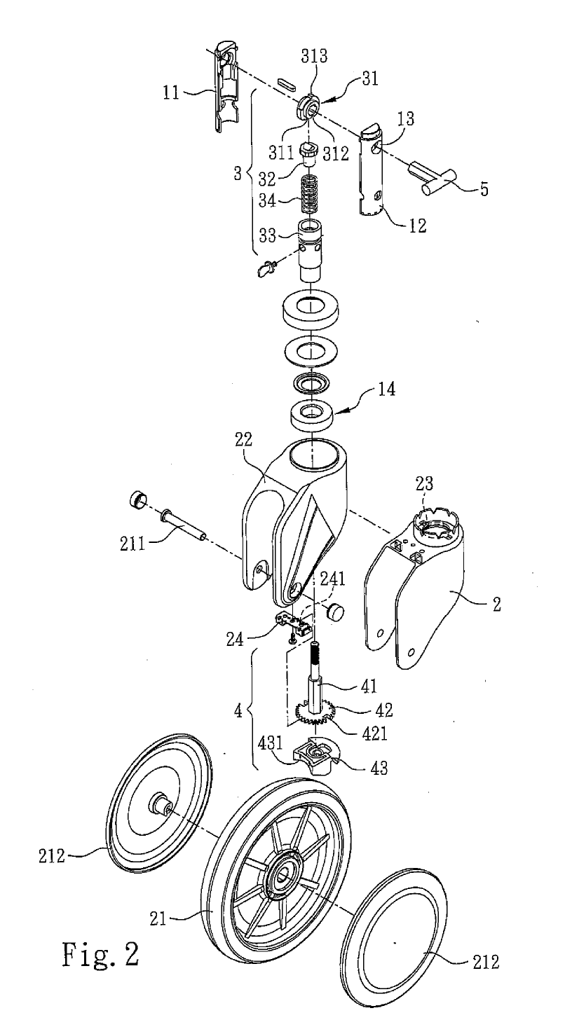

With reference to FIGS. 1, 2 and 3, a truckle in accordance with the present invention comprises a swiveling shaft 1, a rack 2, a driving unit and an arresting unit 4.

The swiveling shaft 1 comprises a first casing 11 and a second casing 12 assembled together. A through hole 13 is defined near an end of the swiveling shaft 1. A bearing 14 is provided on another end of the swiveling shaft 1.

The rack 2 has an end connecting with the bearing 14. A wheel 21 is movably assembled on another end of the rack 2. The wheel 21 has a central shaft 211 movable pivoted on the rack 2, and side covers 212 on opposing sides thereof. A plastic shell 22 envelops the rack 2 for protecting against erosion, ornamenting the rack 2, and shielding from static. A projection 23 extends from an inward surface of the rack 2. A latch portion 24 is formed on an inward surface of the plastic shell 22, and forms a dental portion 241 on a side thereof.

The driving unit 3 is received in the swiveling shaft 1, and comprises a rotating member 31 corresponding to the through hole 13, a push member 32 corresponding to a peripheral of the rotating member 31, a sleeve 33 telescopically mounted on the push member 32, and a resilient member 34 on the sleeve 33 and abutting the push member 32. A first cutout 311 and a second cutout 312 are respectively defined on a peripheral of the rotating member 31. A flange 313 is formed on a peripheral of the rotating member 31. A driving pin 5 extends through the through hole 13 and is mounted on the rotating member 31.

The arresting unit 4 is assembled with the driving unit 3, and comprises an axis pole 41, a gear disc 42 mounted on the axis pole 41 for corresponding to the latch portion 24, and an arresting block 43 below the gear disc 42 and corresponding to the wheel 21. The axis pole 41 extends into the sleeve 33 for assembling with the push member 32. A slot 421 is defined in the gear disc 42 for corresponding to the projection 23. The arresting block 43 forms a barbed surface 431 on a side thereof and corresponding to the wheel 21.

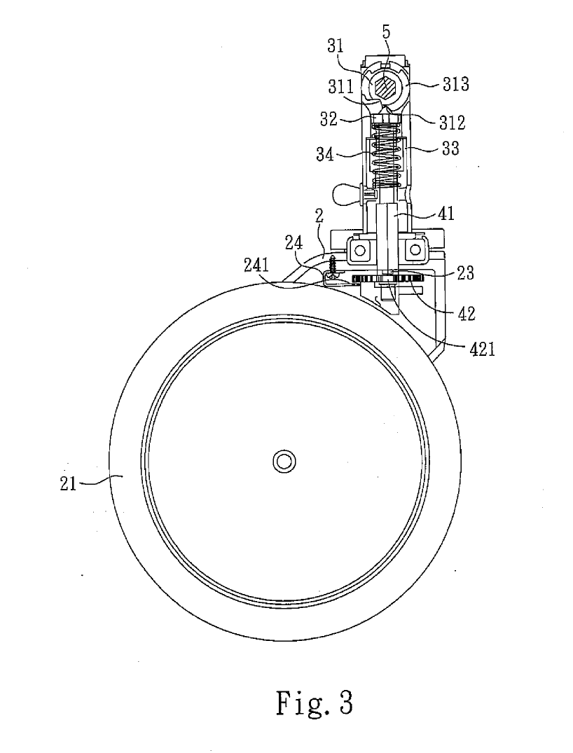

Further referring to FIGS. 3, 4 and 5, in use, the swiveling shaft 1 is assembled on a bottom of a carried object (not shown). As shown in FIG. 3, when the object is moved, the push member 32 of the driving unit 3 abuts against the second cutout 312 of the rotating member 31. The gear disc 42 and the arresting block 43 of the arresting unit 4 are separate from the latch portion 24 and the wheel 21. The rack 2 and the wheel 21 are free to rotate and change direction.

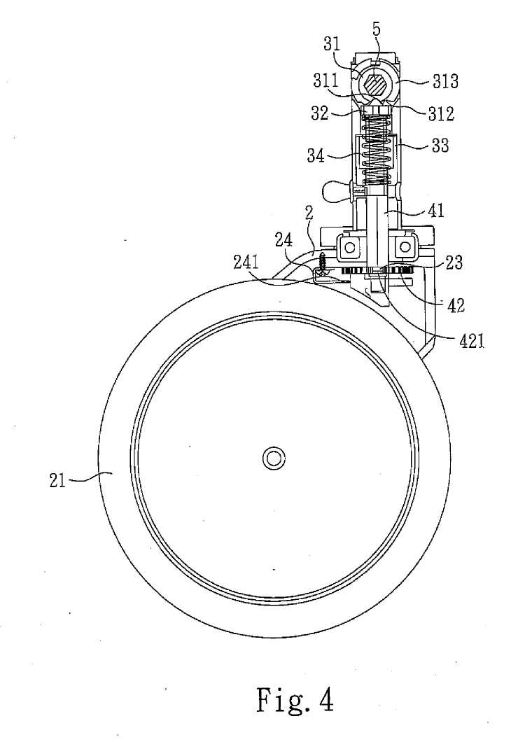

The driving pin 5 extends through the through hole 13 of the swiveling shaft 1 and is mounted on the rotating member 31. In order to limit direction of the truckle solely, the driving pin 5 drives the push member 32 to abut against the first cutout 311 of the rotating member 31. The axis pole 41 moves up with the resiliency of the resilient member 34. The gear disc 42 is brought to abut against an inward surface of the rack 2. The projection 23 is embedded into the slot 421 of the gear disc 42, positioning the rack 2 and limiting direction of the truckle, as shown in FIG. 4.

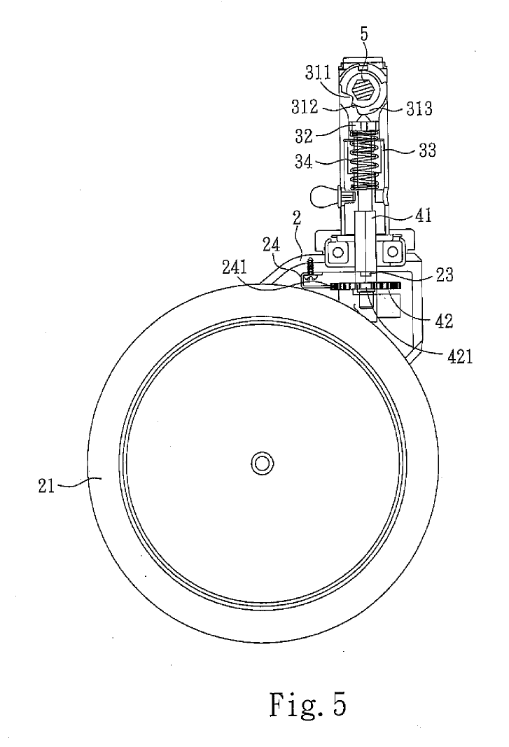

In order to limit direction and rotation of the truckle at the same time, the driving pin 5 rotates the rotating member 31. The flange 313 of the rotating member 31 abuts against the push member 32. The axis pole 41 moves downward and presses the resilient member 34. The gear disc 42 and the arresting block 43 move down. The gear disc 42 meshes with the dental portion 241 of the latch portion 24. The barbed surface 431 of the arresting block 43 retain the wheel 21 firmly, positioning the rack 2 and the wheel 21 and limiting direction and rotation of the truckle, as shown in FIG. 5.

As described above, the truckle of the present invention can either limit direction thereof solely or limit direction and rotation simultaneously. In addition, the truckle has firm structure and can be arrested reliably.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A truckle comprising:
a swiveling shaft defining a through hole near an end thereof, and having a bearing on another end thereof;
a rack having an end connecting with the bearing, a wheel being movably assembled on another end of the rack, a plastic shell enveloping the rack, a projection extending from an inward surface of the rack, a latch portion being formed on an inward surface of the plastic shell;
a driving unit being received in the swivel shaft, and comprising a rotating member corresponding to the through hole, a push member corresponding to a peripheral of the rotating member, a sleeve telescopically mounted on the push member, and a resilient member on the sleeve and abutting the push member; and
an arresting unit being assembled with the driving unit, and comprising an axis pole, a gear disc mounted on the axis pole for corresponding to the latch portion, and an arresting block mounted below the gear disc and corresponding to the wheel, the axis pole extending into the sleeve for assembling with the push member, a slot being defined in the gear disc for corresponding to the projection.

2. The truckle as claimed in claim 1, wherein the swiveling shaft comprises a first casing and a second casing assembled together.

3. The truckle as claimed in claim 1, wherein the wheel has a central shaft movable pivoted on the rack, and side covers on opposing sides thereof.

4. The truckle as claimed in claim 1, wherein a dental portion is formed on a side of the latch portion for meshing with the gear disc.

5. The truckle as claimed in claim 1, wherein a driving pin extends through the through hole of the swiveling shaft, a first cutout and a second cutout being respectively defined on a peripheral of the rotating member, a flange being formed on a peripheral of the rotating member.

6. The truckle as claimed in claim 1, wherein the arresting block forms a barbed surface on a side thereof and corresponding to the wheel.
